(19) United States
(12) Patent Application Publication
(10) Pub. No.: US 2025/0148514 A1
(43) Pub. Date: May 8, 2025

(54) SYSTEMS AND METHODS FOR ITEM-LEVEL AND MULTI-CLASSIFICATION FOR INTERACTION CATEGORIZATION

(71) Applicant: Capital One Services, LLC, McLean, VA (US)

(72) Inventors: Allison FENICHEL, Brooklyn, NY (US); Nishant GARG, Fremont, CA (US); Victoria MARTINS, Pinole, CA (US)

(73) Assignee: Capital One Services, LLC, McLean, VA (US)

(21) Appl. No.: 18/504,669

(22) Filed: Nov. 8, 2023

(51) Int. Cl. G06Q 30/0601; G06F 16/906; G06N 20/00

(52) U.S. Cl. CPC G06Q 30/0621; G06F 16/906; G06N 20/00

(57) ABSTRACT

A method for categorization may initiate a local instance of a widget on a device of a user, the widget including a first model. The method for categorization may include retrieving, by the widget, a first data set from the device of the user, the first data set associated with one or more datum of an active user session. The method for categorization may include scoring, by the model, a first item based at least in part on the first data set. The method for categorization may include labeling the first item based on a result of the scoring. The method for categorization may include sending, by the widget, a result of the labeling to a remote server.

### TECHNICAL FIELD

Various embodiments of this disclosure relate generally to machine-learning-based techniques for categorization, and, more particularly, to systems and methods for item-level and multi-classification for interaction categorization.

### BACKGROUND

In the current financial industry, interaction categorization is primarily done at the merchant level, as interactions are tied at a granular level to a specific merchant, rather than an individual item. The primary method for categorizing interactions is through the use of merchant category codes (MCC), which are 4-digit values that map to category names. While these codes provide a broad categorization of merchants, they can be insufficient for accurately representing the wide variety of items that may be sold by a single merchant.

For instance, large retailers may sell items that fall under multiple categories, such as groceries, toys, home goods, gas station products, and more. The current categorization system based on MCCs may not effectively capture these distinctions, and in some cases, the assigned categories may be vague, such as “miscellaneous” or “software services”.

Conventional techniques, including the foregoing, fail to provide an effective solution for accurately categorizing interactions at the items level. These traditional methods often rely on broad merchant categories, which can be insufficient in capturing the diverse range of items sold by a single merchant. Furthermore, the existing systems may not be applicable to online or card-not-present interactions, limiting their usefulness in today's increasingly digital economy.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for categorization.

In some aspects, the techniques described herein relate to a computer-implemented method for categorization, including: initiating a local instance of a widget on a device of a user, the widget including a first model; retrieving, by the widget, a first data set from the device of the user, the first data set associated with one or more datum of an active user session; scoring, by the model, a first item based at least in part on the first data set; labeling the first item based on a result of the scoring; and sending, by the widget, a result of said labeling to a remote server.

In some aspects, the techniques described herein relate to a system for categorization, including: a memory storing instructions and a trained machine learning model trained, based on item information data and ground truth, to learn associations between an item offering and output an item label in response to an input data set; and a processor operatively connected to the memory and configured to execute the instructions to perform operations including: initiating a local instance of a widget on a device of a user, the widget including a first instance of the machine learning model; retrieving, by the widget, a first data set from the device of the user, the first data set associated with one or more datum of an active user session; scoring, by the first instance of the machine learning model, a first item based at least in part on the first data set; labeling the first item based on a result of the scoring; and sending, by the widget, a result of said labeling to a remote server.

In some aspects, the techniques described herein relate to a computer-implemented method for dynamic item recommendations, including: receiving a first request from a user, the first request including one or more user preferences, user attributes, or contextual data; retrieving one or more data sets associated with user behavior data from one or more data sources, the user behavior data including one or more of browsing history, purchase history, item ratings, or reviews; scoring a set of items based on the retrieved data sets using a machine learning model, the machine learning model being trained on an item feature space that represents item attributes and characteristics; selecting, based on a result of the scoring, one or more items as recommended items for the user, the one or more items being selected based on their scores and relevance to one or more of user behaviors data, user preferences, attributes, or contextual data; and presenting the recommended items to the user on a user interface.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for training and/or using a machine-learning model for categorization, according to some embodiments of the disclosure.

FIG. 2A depicts an exemplary categorization platform, according to some embodiments of the disclosure.

FIG. 2B depicts an exemplary machine-learning module, according to some embodiments of the disclosure.

FIG. 3 illustrates an exemplary process for categorization, according to some embodiments of the disclosure.

FIG. 4 shows an exemplary machine-learning training flow chart, according to some embodiments of the disclosure.

FIG. 5 is a functional block diagram of a computer, according to exemplary embodiments of the present disclosure.

### DETAILED DESCRIPTION OF EMBODIMENTS

According to certain aspects of the disclosure, methods and systems are disclosed for interaction categorization, e.g., item-level categorization. As used herein, “categorization” generally encompasses distinct groupings of products or the like based on distinctive characteristics, how such items are marketed, distributed or the like. Categories may be hierarchical, e.g., in order to capture multiple levels of granularity with regard to item features. Current interaction categorization methods, primarily based on merchant category codes (MCC), are limited in accurately representing the wide variety of items sold by merchants. Conventional techniques may not be suitable. For example, conventional techniques often rely on broad merchant categories, which can be insufficient and may not apply to online or card-not-present interactions. Accordingly, improvements in technology relating to interaction categorization are needed.

As will be discussed in more detail below, in various embodiments, systems and methods are described for using machine learning to classify and/or categorize items. By training a machine-learning model, e.g., via supervised or semi-supervised learning, to learn associations between item and/or merchant data and corresponding item categories and/or classifications, the trained machine-learning model may be usable to accurately categorize interactions at the item level.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or item that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, product, or the like having ownership or other rights that may be transferred. As used herein, terms like “user” or “customer” generally encompasses any person or entity that may desire information, resolution of an issue, purchase of an item, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a computer-based process that categorizes items using a widget on a user's device is provided. The widget collects data from the user's active session, such as HyperText Markup Language (HTML) code, metadata, or item tags, and uses a machine learning model to score and rank potential item categories based on this data and user behavior. If a category meets a predefined threshold, the highest-scoring category is selected; otherwise, a default category is chosen. The widget then sends the categorization results to a remote server, which can be used to adjust the user's experience, such as by limiting certain actions to specific item categories.

While the examples above involve item categorization, it should be understood that techniques according to this disclosure may be adapted to any suitable type of data suitable for categorization. It should also be understood that the examples above are illustrative only. The techniques and technologies of this disclosure may be adapted to any suitable activity.

Presented below are various aspects of machine learning techniques that may be adapted to categorization. As will be discussed in more detail below, machine learning techniques adapted to classification of items and merchants based on website and/or item data may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

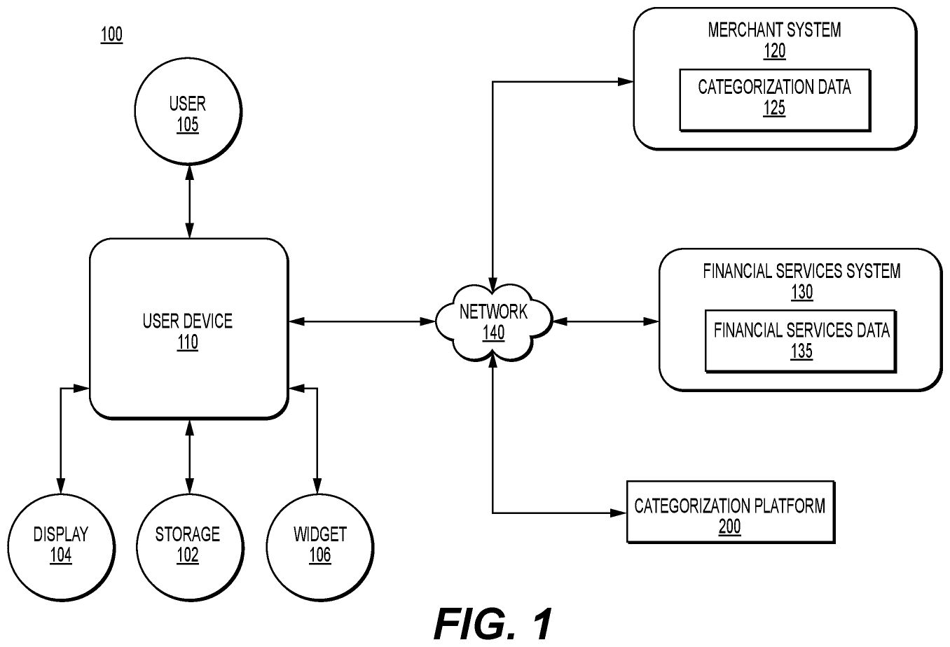

FIG. 1 depicts an exemplary environment 100 that may be utilized with techniques presented herein. One or more user device(s) 110, merchant system 120, financial services system 130, or the like, may communicate across an electronic network 140. As will be discussed in further detail below, one or more categorization platform(s) 200 may communicate with one or more of the other components of the environment 100 across electronic network 140. The one or more user device(s) 110 may be associated with a user 105, e.g., a user associated with one or more of generating, training, or tuning a machine-learning model for categorization, generating, obtaining, or analyzing item classification data, or the like.

In some embodiments, the components of the environment 100 are associated with a common entity, e.g., a financial institution, interaction processor, merchant, or the like. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, or use a machine-learning model for categorization, among other activities.

The user device 110 may be configured to enable the user 105 to access and/or interact with other systems in the environment 100. For example, the user device 110 may be a computer system such as, for example, a desktop computer, a mobile device, a tablet, etc. In some embodiments, the user device 110 may include one or more electronic application(s), e.g., a program, plugin, browser extension, etc., installed on a storage 102 of the user device 110. In some embodiments, the electronic application(s) may be associated with one or more of the other components in the environment 100. For example, the electronic application(s) may include one or more of system control software, system monitoring software, software development tools, etc.

In various embodiments, the electronic network 140 may be a wide area network (“WAN”), a local area network (“LAN”), personal area network (“PAN”), or the like. In some embodiments, electronic network 140 includes the Internet, and information and data provided between various systems occur online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The merchant system 120 may include categorization data 125 associated with the items or services offered by the merchant. The merchant system 120 may communicate with the categorization platform(s) 200 to provide or receive information related to item classification, adjustments, or analysis. In some embodiments, the merchant system 120 may provide the categorization data 125 and/or information indicative of an item category as part of the session with the user device, such as via HTML code, metadata, or other structured data formats used for displaying item information on the merchant's website. In some embodiments, the categorization platform 200 may leverage such existing infrastructure and processes employed by merchants when providing item classification information to users.

Categorization data 125 may be associated with individual items, merchants, or both, depending on the context and requirements of a particular application. In some embodiments, categorization data 125 may include information that classifies or characterizes items based on various attributes, such as item type, brand, price range, materials, functionality, or other relevant features. This categorization data may be used to organize, filter, or search for items within a database or online marketplace, and may be beneficial for both users and merchants in facilitating item discovery, comparison, and purchasing decisions.

Categorization data 125 may come in various forms, such as item descriptions, HTML meta tags, and keywords, to effectively classify and characterize items or merchants. Item descriptions may provide detailed information about an item's features, functionality, and benefits, and thus may serve as a rich source of categorization data. HTML meta tags, often embedded within a webpage's source code, may contain one or more metadata about the content of the page, including item or merchant attributes, which can be utilized for categorization purposes. Keywords, on the other hand, may represent a concise summary of the attributes or characteristics of an item or merchant, and may be useful in search engine optimization and targeted advertising.

The financial services system 130 may include financial services data 135 related to interactions, user accounts, or other financial activities. The financial services system 130 may interact with the categorization platform(s) 200 to exchange data for the purpose of analyzing interaction patterns, generating insights, or providing customized recommendations based on the categorization data.

The financial services data 135 may include various types of information related to the financial activities and profiles of users. This data may include user profiles, interaction details, account balances, credit scores, and other relevant financial information associated with a user. User profiles may consist of personal information, such as name, address, contact details, and financial account numbers, as well as preferences and settings related to the user's financial services.

Interaction data within the financial services data 135 may comprise a comprehensive record of the user's financial activities, including purchase history, payments, deposits, withdrawals, transfers, and other interactions associated with their accounts. This interaction data can provide one or more insights into the user's spending habits, preferences, and financial behaviors, enabling the financial services system 130 to offer personalized services, targeted offers, and tailored recommendations to the user.

The user device 110 may include a widget 106 that allows the user 105 to access and interact with the categorization platform(s) 200 or other components in the environment 100. The widget 106 may provide a user interface for the user 105 to view, modify, or analyze the categorization data, as well as to manage or monitor the machine-learning model.

In some embodiments, the environment 100 may include additional components or systems that interact with the categorization platform(s) 200 or other components in the environment. These additional components may provide supplemental data, services, or functionality to support the categorization process or to enhance the user experience.

As discussed in further detail below, the categorization platform(s) 200 may one or more of (i) generate, store, train, or use a machine-learning model configured to find associations between item and/or merchant data and classifications and/or categories. The categorization platform(s) 200 may include a machine-learning model and/or instructions associated with the machine-learning model, e.g., instructions for generating a machine-learning model, training the machine-learning model, using the machine-learning model, etc. The categorization platform(s) 200 may include instructions for retrieving item classification data, adjusting item classification data, e.g., based on the output of the machine-learning model, and/or operating the display 104 to output categorization data, e.g., as adjusted based on the machine-learning model. The categorization platform(s) 200 may include training data, e.g., item data, and may include ground truth, e.g., classification data.

In some embodiments, a system or device other than the categorization platform(s) 200 is used to generate and/or train the machine-learning model. For example, such a system may include instructions for generating the machine-learning model, the training data and ground truth, and/or instructions for training the machine-learning model. A resulting trained-machine-learning model may then be provided to the categorization platform(s) 200.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between item and/or merchant data and categorization data, such that the trained machine-learning model is configured to determine an output category or classification in response to the input item and/or merchant data based on the learned associations.

In some embodiments, distributed learning approaches such as federated learning enable collaboration among multiple clients while maintaining privacy by performing training on decentralized devices. Each client retains its local dataset and shares parameters with other clients during aggregation steps, ensuring efficient use of resources and preserving privacy without compromising the security of sensitive information. For example, each device may retain their local dataset and only share parameters with others during aggregation steps. Clients periodically synchronize updates after training locally on respective datasets, allowing for a seamless collaborative process that balances individual autonomy and collective progress. This distributed approach enables effective learning capabilities without sacrificing data confidentiality or control over how information is shared among participants.

In some embodiments, a central model is utilized. The central model serves as the foundation for the standard against which all other models are compared and updated, acting as a reference point of truth for the overall learning process. It can be trained using a combination of local models from participating clients' updates or solely on its own, depending on the specific implementation. By maintaining this centralized resource, consistency and accuracy can be ensured across all participating devices while still allowing for distributed training and collaboration among them. This centralized approach balances the benefits of decentralization with the desire for a unified standardized source of knowledge and guidance.

In various embodiments, the variables of a machine-learning model may be interrelated in any suitable arrangement in order to generate the output. For example, in some embodiments, the machine-learning model may include image-processing architecture that is configured to identify, isolate, and/or extract features, geometry, and or structure in one or more of categorization data. For example, the machine-learning model may include one or more convolutional neural network (“CNN”) configured to identify features in the item and/or merchant data, and may include further architecture, e.g., a connected layer, neural network, etc., configured to determine a relationship between the identified features in order to determine a category associated with the item and/or merchant data.

In some instances, different samples of training data and/or input data may not be independent. Thus, in some embodiments, the machine-learning model may be configured to account for and/or determine relationships between multiple samples.

For example, in some embodiments, the machine-learning model of the categorization platform(s) 200 may include a Recurrent Neural Network (“RNN”). Generally, RNNs are a class of feed-forward neural networks that may be well adapted to processing a sequence of inputs. In some embodiments, the machine-learning model may include a Long Shor Term Memory (“LSTM”) model and/or Sequence to Sequence (“Seq2Seq”) model. An LSTM model may be configured to generate an output from a sample that takes at least some previous samples and/or outputs into account.

Although depicted as separate components in FIG. 1, it should be understood that a component or portion of a component in the environment 100 may, in some embodiments, be integrated with or incorporated into one or more other components. For example, a portion of the display 104 may be integrated into the user device 110 or the like. In another example, the categorization platform(s) 200 may be integrated into the widget 106, the user device 110, or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized for classification are discussed in further detail in the methods below. In the following methods, various acts may be described as performed or executed by a component from FIG. 1, the user device 110, widget 106, the financial services system 130, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

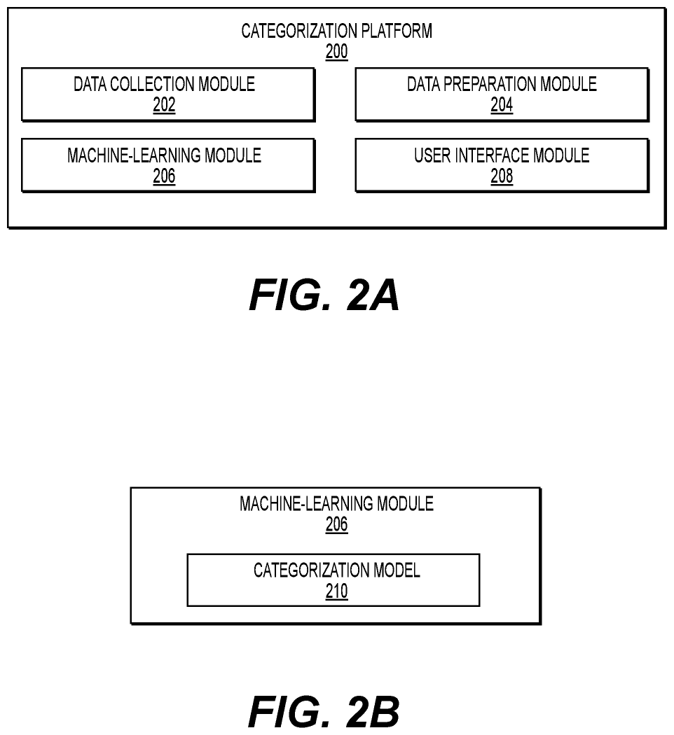

FIG. 2A illustrates an exemplary categorization platform 200, which may be associated with or integrated into the widget 106, and utilized for processing and classifying categorization data related to one or more items and/or merchants. The categorization platform 200 includes various components that work together to intake, process, and categorize data obtained during a user session, such as data scraped from a browser page associated with a merchant or an item. These components include the data collection module 202, data preparation module 204, machine-learning module 206, and the user interface module 208.

The data collection module 202 is responsible for gathering the categorization data during a user session. This may involve scraping a browser page or obtaining data directly from the merchant system 120. The collected data may include item descriptions, HTML meta tags, keywords, and other relevant information associated with the item or merchant. The data may further include one or more transaction receipt associated with the financial system 130, such as a receipt associated with one or more user account. The receipt may include data such as purchase date and time, item description, price, total cost, payment method, merchant information transaction identifier, user information, and other information which may be relevant to the transaction.

Once the data collection module 202 has gathered the one or more categorization data, the data preparation module 204 processes and prepares the data for analysis by the machine-learning module 206. The data preparation module 204 may involve cleaning the data, removing irrelevant or redundant information, and converting the data into a suitable format for further processing by the machine-learning module 206.

The machine-learning module 206 receives the prepared data from the data preparation module 204 and applies machine learning algorithms and models to classify or categorize the items and/or merchants based on the input data. The machine-learning module 206 may use various algorithms such as supervised learning, unsupervised learning, or reinforcement learning, and may utilize a variety of models, including neural networks, decision trees, or support vector machines, to accomplish its task.

After the machine-learning module 206 has classified or categorized the items and/or merchants, the user interface module 208 presents the results to the user, who may be a customer, a merchant, or a financial services provider. The user interface module 208 can provide an interactive and intuitive interface, enabling the user to view, modify, or confirm the categorization results. The user interface module 208 may also allow the user to provide feedback or additional information to improve the categorization process or adjust the machine-learning model accordingly.

FIG. 2B presents a more detailed view of the machine-learning module 206 and its relationship with the categorization model 210. As previously mentioned, the machine-learning module 206 applies machine learning algorithms and models to classify or categorize items and/or merchants based on the prepared input data provided by the data preparation module 204.

The machine-learning module 206 may encompass various subcomponents and processes to ensure accurate and efficient categorization. One element of the machine-learning module 206 is the categorization model 210, which serves as the computational model responsible for making predictions and classifications based on the input data. The categorization model 210 may be a pre-trained model or a model specifically designed and trained for the task of categorizing items and merchants within the given context.

The development of the categorization model 210 may involve multiple steps, including feature extraction, model selection, training, validation, and evaluation. Feature extraction is the process of identifying and extracting relevant features from the prepared data, which will be used as input for the categorization model 210. These features may include textual information from item descriptions, keywords, HTML meta tags, or any other relevant data points that can aid in the classification process.

Model selection is the process of choosing the most suitable machine learning algorithm or model for the categorization task. This may involve comparing various algorithms such as decision trees, support vector machines, neural networks, or ensemble methods, and selecting the one that provides the best performance based on predefined criteria, such as accuracy or computational efficiency.

The categorization model 210 may be trained using a dataset that includes both input features and corresponding ground truth labels. The training process involves adjusting the model's parameters to minimize the error between the model's predictions and the ground truth labels. This process may include using techniques such as gradient descent, backpropagation, or other optimization algorithms.

After the training process, the categorization model 210 may be validated and evaluated using a separate dataset not used during training. This allows for an assessment of the model's performance on unseen data, providing insights into its generalization capabilities and ensuring that it can accurately categorize items and merchants in real-world scenarios.

The categorization model 210 may be integrated into the machine-learning module 206, which then utilizes the model to make predictions and classifications based on the prepared input data. The results generated by the categorization model 210 are then passed on to the user interface module 208 for presentation to the user, as previously discussed.

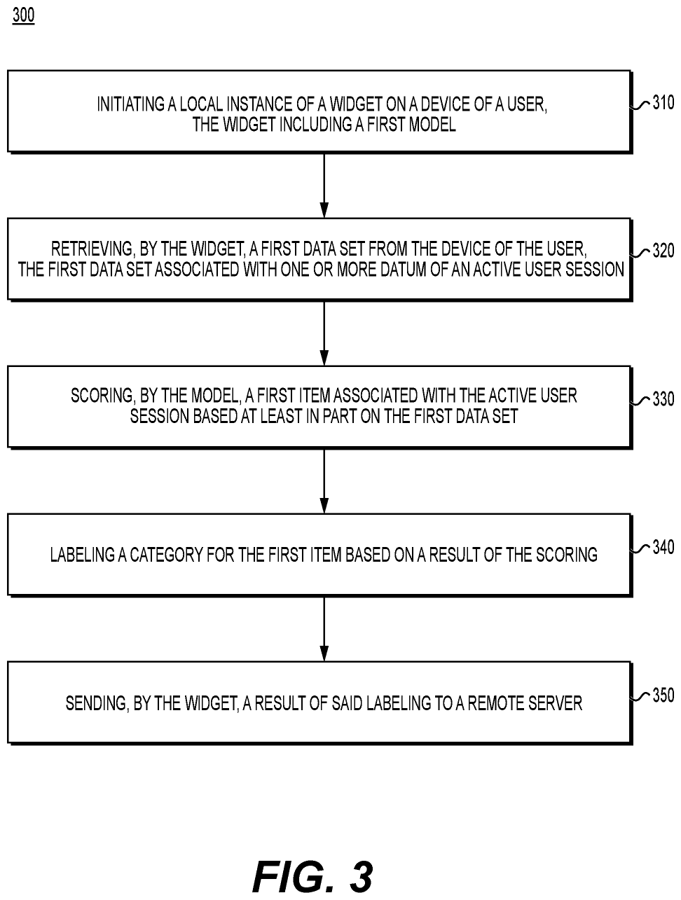

FIG. 3 illustrates an exemplary process for categorization 300, e.g., by utilizing a trained machine-learning model such as a machine-learning model trained according to one or more embodiments discussed above. Step 302, the process involves initiating a local instance of a widget 106 on a user device 110. The widget 106 includes a first model, which may be a machine learning model used for scoring purposes. This model may be running in a browser associated with the user device 110 and may be implemented as a federated machine learning model. For example, the model may be a local model within a federated learning system. This allows the model to be distributed across multiple user devices while maintaining a consistent and synchronized version of the model.

The initiation of the local instance of the widget 106 may be done by a remote server, such as a server associated with the financial services system 130. The remote server may initiate the widget 106 by either starting the service on the user device 110 or by downloading the model to the user device 110. The widget 106 may periodically update the model to ensure that it is using the most current version of the model, and/or the model may periodically call back to the remote server to verify that it has the latest version.

In some embodiments, the first model may be a “master” or central version of the model, which is maintained and updated on a remote server. The local instance of the widget 106 on the user device 110 communicates with the master model on the remote server, ensuring that the local model is kept up-to-date and synchronized with the master model.

At step 304, the widget 106 retrieves a first data set from the user device 110 during an active user session. The first data set is associated with one or more datum related to the user's interaction with the device, such as their browsing activities, item selection, or purchase behavior. The data collected may include HyperText Markup Language (HTML) code, metadata, item tags, or other relevant information that can aid in the categorization of one or more item, e.g., items offered for sale on an online store.

For example, the active user session may involve the user browsing an online store, comparing items, or completing a purchase. The widget 106, in some embodiments, may perform real-time scraping and/or assessment of the content displayed on the user device 110 during the active user session. By capturing this information, the widget 106 can better understand the user's preferences, actions, and the context of the item being considered for purchase.

In addition to the content-based data, the widget 106 may also collect various user behavior data during the active user session. This can include information such as the time and date of the session, dwell time on particular pages or items, pointer location, clicks, and other user interaction data that can be accessed through the browser. Collecting and analyzing this user behavior data can provide one or more insights into the user's preferences, interests, and shopping habits, allowing the widget 106 to more accurately categorize the item(s) being considered.

At Step 306, the machine learning model within the widget 106 performs the scoring process for one or more items based on the first data set retrieved in Step 304. The scoring process takes into consideration one or more of the content-based data, such as HTML code, metadata, and item tags, and/or the user behavior data collected during the active user session. The combination of these data sources allows the machine learning model to make a well-informed decision when categorizing the item(s).

The scoring process may involve generating a ranking of potential item categories for the item(s). This ranking is based on the analysis of the first data set, and the machine learning model assigns a score to each potential item category, indicating the likelihood of the item belonging to that category. The model may also consider any pre-defined threshold values to ensure that the scoring results in at least one potential item category that satisfies the threshold.

In some embodiments, the scoring process may also take into account additional user behavior data, such as the user's browsing history, previously purchased items, or demographic information. By incorporating this additional information, the machine learning model can further refine the categorization process, tailoring the results to better reflect historical user behavior and its association with one or more categories.

The scoring process may result in the generation of a scoring vector, which represents the relative scores assigned to each potential item category. This vector serves as an indicator of the most suitable item categories or classifications for the item based on the analysis of the first data set and any additional user behavior data.

The scoring vector, as generated during the scoring process, may comprise a series of numerical values, each value corresponding to a specific potential item category. These numerical values indicate the relative strength or likelihood of the first item being associated with each respective category. The scoring vector allows for a quantitative representation of the machine learning model's analysis and decision-making process, facilitating the comparison and ranking of the potential item categories.

In some embodiments, the scoring vector may be normalized to ensure that the sum of the numerical values equals one, or alternatively, that the maximum value in the vector is equal to one. This normalization process can provide a more interpretable and standardized representation of the scoring results, enabling easier comparison of the categorization outcomes for different items or user sessions.

At Step 308, the item(s) are labeled based on the results of the scoring process conducted in Step 306. The labeling process involves assigning the item(s) to a specific item category, e.g., according to the scores generated by the machine learning model. This assignment may assist in organizing and classifying items, which may influence the user experience and potentially impacting the financial services system.

Two potential scenarios may occur during the labeling process. In a first scenario, if the scoring results in at least one potential item category that satisfies a pre-defined threshold, an item may be assigned to the highest scoring potential item category among the plurality of potential item categories. This ensures that the item is categorized according to the most suitable category based on the analysis of the first data set and any additional user behavior data. In a second scenario, if none of the potential item categories satisfy the pre-defined threshold, the first item may be assigned to a default item category, which is associated with none of the potential item categories. The default item category may serve as a miscellaneous category for items that do not clearly fit into any of the predefined categories based on the scoring process. This approach allows for flexibility in categorizing items that may not have a well-defined category or may have insufficient data for accurate categorization.

At Step 310, the widget 106 sends the result of the labeling process, conducted in Step 308, to a remote server. The remote server may be associated with the financial services system 130, and it is responsible for processing, storing, and managing the item categorization data received from the widget 106. In this manner, information about the category or categories of items involved in a purchase may be provided to the remote server, e.g., without including item-level data or other private data of the user. This may facilitate obtaining information about the vendor and/or the user's purchase without compromising the user's privacy.

Depending on the implementation, the scoring and labeling may take place either within the widget 106 itself or within the remote server. In some embodiments, where the scoring takes place entirely within the widget 106, one or more machine-learning model runs locally, such as in a web browser. The item-level data associated with the transaction is utilized within the model, but does not need to be transferred to a remote server. In such embodiments where the scoring and labeling processes are performed by the widget 106, then only the label and an identifier of the item, items, and/or merchant are sent back to the remote server. This approach can reduce the amount of data transmitted between the user device 110 and the remote server, potentially improving data privacy and efficiency.

Alternatively, if only features are computed in the widget 106, then the features are sent to the remote server, where the scoring and labeling processes take place. In this case, the remote server receives the feature data and applies the machine learning model to score and label the first item accordingly.

Regardless of where the scoring and labeling processes occur, the data transmitted to the remote server may be anonymized before sending, ensuring the privacy of the user's data. Upon receiving the data, the remote server assesses and stores one or more labels associated with the interaction, which can then be used for various purposes such as adjusting the user experience, generating item recommendations, or managing financial services features based on the item categorization.

In some embodiments, a single transaction and/or action may be associated with multiple items, where each item may be deemed to be associated with its own classification and/or item category. In such embodiments, the system, such as platform 200, intakes details of a single transaction that include a plurality of items associated with the transaction. For example, consider a transaction that includes multiple products. The system may be configured to map each item to its respective category, resulting in multiple categories being associated with the same transaction. This mapping of items to a category can be achieved through the use of item-level information, which allows the system to determine the individual categories for each item within the transaction. This approach has the potential to provide a more accurate and granular categorization compared to traditional methods that only associate a single category with a transaction and/or a merchant only being associated with a single category or merchant code. For example, consider a purchase at a single merchant which includes items of varying nature, such as shoes, milk, and electronics. In this scenario, instead of or in addition to classifying the transaction with a single category based on the merchant code, the system can instead/additionally categorize each item based on the product-level information and/or categorize the transaction using multiple categories based on different purchased items. In this example, the three items may be given different and distinct categories. By way of another example, if a purchase includes multiple items which are similar, such as two pairs of socks, the system may still only associated the transaction with one category associated with socks, as each item within the transaction would fall under the same transactional category. This offers flexibility when compared to traditional merchant-based codes. When evaluating transactions with multiple items, the system may be configured to identify each item individually and perform the categorization individually on each item, and then generate a data object which includes one or more item and/or the entire transaction and all categories associated with the one or more item and/or the transaction. In this way, a single transaction and/or user interaction can be both multi-item and multi-classification.

In some embodiments, upon classification, a data object may be generated which includes an item associated with a transaction and/or a transaction (which may include multiple items), one or more data associated with the item and/or transaction, and the category assigned to the item. The data object may include multiple items, in the case of a multi-item, multi-classification categories of the transaction. Moreover, in some embodiments, the data object may also include metadata related to the transaction. This metadata could encompass transaction time, location, transaction method, parties involved, one or more codes associated with a party (such as a merchant code), and similar data. Such metadata can provide further context to the classification process and can be leveraged to refine the classification algorithms.

When the transaction involves multiple items, the data object may also contain a unique identifier for each item, serving to distinguish each in the context of the transaction. This unique identifier can include an SKU, product ID, barcode, or any other item-specific information that can be correlated to the item in the transaction. The data object can also incorporate a confidence score for each classification. This score represents the probability that the classification is accurate according to the underlying machine learning model. It provides a measure of the reliability of the classification and can be used for additional analyses or decision-making processes. In the scenario of multi-item, multi-classification transactions, the data object might also encapsulate the relationships between items. These relationships could be based on their co-occurrence in the transaction or any other relationships inferred from the data. This property allows the system to identify patterns or associations among different items and across transactions, which could be instrumental in understanding consumer behavior or trends, enhancing supply chain management, or improving product recommendations.

In some embodiments, the data object might be structured in a way that allows for easy integration with other systems or databases, including financial services system 130. This could involve using standardized formats or protocols, making the data object interoperable and enhancing its usefulness across various applications and systems. In this manner, the data object serves as a comprehensive, dynamic, and adaptable representation of a transaction and its components, forming a valuable asset in a wide range of analytical and operational settings.

In some embodiments, categories for items and/or transactions for a particular merchant may be stored and/or aggregated, e.g., in order to build or maintain a database or map of merchants to categories. Such information may be propagated, for example, to local widgets 106 in order to provide context for which categories to consider when classifying items in a transaction. Such “bootstrapping” of which categories to consider when classifying an item in a transaction may improve the efficiency of the model. Moreover, an identification of a classification for an item that is an outlier from what is expected for a particular merchant may be an indication of a misidentification of the item or another issue, and may, for example, prompt clarification of the item or category, e.g., by the user or by a person associated with the merchant or the widget 106.

In some instances, data such as a credit card statement or the like may require or prefer a single merchant code per transaction. In some embodiments, if multiple classifications are assigned to a single transaction, the widget 106 may be configured to, for example, select one of the multiple classifications, e.g., that includes a a higher portion of items from the transaction than other categories. In another embodiment, the widget 106 may split the transaction into separate transactions, one for each category.

In an exemplary use case, such separated transaction data may be provided to a budget tool associated with the user. This may enable the user to better track and understand their transaction history. For instance, a user may have a monthly budget for categories like food and cleaning products. Items of both categories might be obtained at a single merchant. Conventionally, separately tracking a budget for each category would require the user to comb through their receipts item by item. Conversely, the data supplied by the widget 106 may provide separate transactions for each category, and thus simplify this process.

In addition to the aforementioned steps of the method, the categorization process may also include adjusting the user experience based on the results of the labeling. This adjustment can enhance personalization and improve the overall user experience in various ways.

In some embodiments, the adjustment to the user experience involves binding a first instrument of the user to an instrument item category. In some embodiments, the system binds certain financial accounts to interactions for only specific item categories, such that the instrument is unable to complete a workflow for an item outside of the instrument item category. For example, a credit card may be restricted to purchasing items within a particular category, such as groceries or gas. This restriction prevents the instrument from completing a workflow for an item outside of the designated instrument item category, providing users with better control over their spending habits.

In some embodiments, e.g., embodiments in which a transaction is split into multiple transactions by category, different instruments (e.g., credit cards) may be associated with different categories. For example, a user may have one card with preferential benefits for purchasing food, and another with preferential benefits for purchasing electronics. By splitting a single transaction with items from both, the user may thus benefit from the advantages of each.

In some embodiments, one or more instruments to be associated with a transaction are a virtual instrument, e.g., a virtual credit card. In an example, a particular virtual card may be generated and/or selected based on a particular category for a transaction.

In some embodiments, the adjustment to the user experience involves implementing a rewards system. The categorization process may be integrated with a rewards system that presents users with customized offers, promotions, or reward structures based on the labeled item categories. By tailoring rewards to the user's preferences and purchasing habits, the system can incentivize users to engage with specific item categories or merchants, which may drive customer loyalty and satisfaction.

In some embodiments, the adjustment to the user experience involves establishing item identifiers. The system can associate certain item identifiers, such as tags, barcodes, or item numbers, with specific item categories. This association can facilitate more accurate and efficient classification and categorization of items, improving the overall user experience and streamlining the categorization process for subsequent interactions.

In some embodiments, the adjustment to the user experience involves injecting code into the user's browser based on item classification. Based on the labeled item categories, the system may inject code into the user's browser to present additional item offerings, display information that may influence purchasing decisions (e.g., reviews from other sites), or adjust the layout of a webpage to drive purchase behavior. For example, the system could modify the position, size, or ordering of item images, alter checkout button locations, or implement animations or font changes to make the purchasing process more appealing and user-friendly.

By adjusting the user experience based on the results of the labeling process, the system can provide a more personalized, relevant, and engaging experience for users. These adjustments can lead to increased customer satisfaction, loyalty, and potentially higher conversion rates for merchants and financial services providers.

In addition to the foregoing, the categorization process may be augmented with dynamic item recommendations to enhance personalization and improve the overall user experience in various ways. The computer-implemented method for dynamic item recommendations may include one or more of following steps.

The method may start with receiving a first request from a user, which includes one or more user preferences, user attributes, or contextual data. Next, the system retrieves one or more data sets associated with user behavior data from one or more data sources. The user behavior data may comprise browsing history, purchase history, item ratings, or reviews.

After retrieving the one or more data sets, the method may include scoring a set of items using a machine learning model. The machine learning model is trained on an item feature space representing item attributes and characteristics. This scoring process takes into account the retrieved data sets, user preferences, attributes, or contextual data.

Based on the results of the scoring, the method selects one or more items as recommended items for the user. These items are chosen based on their scores and relevance to the user's behavior data, preferences, attributes, or contextual data. Finally, the recommended items are presented to the user on a user interface, offering a tailored and personalized shopping experience.

In some embodiments, the dynamic item recommendations method may be integrated with other adjustments to the user experience, such as binding a first instrument of the user to an instrument item category, implementing a rewards system, establishing item identifiers, or injecting code into the user's browser based on item classification, such as discussed above. These additional features can work in tandem with the dynamic item recommendations to further personalize the user experience, incentivize engagement, and streamline the purchasing process.

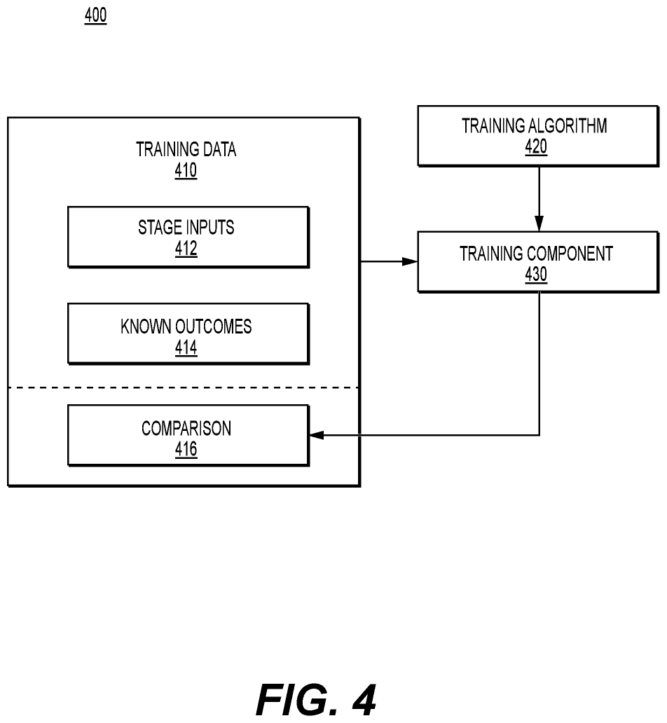

One or more implementations disclosed herein include and/or are implemented using a machine-learning model, such as the categorization model described in the context of the present discussion. For example, one or more of the modules of the categorization platform are implemented using a machine-learning model and/or are used to train the machine-learning model. FIG. 4 shows an example machine-learning training flow chart 400, according to some embodiments of the disclosure. Referring to FIG. 4, a given machine-learning model is trained using the training flow chart 400. The training data 410 includes one or more of stage inputs 412 and the known outcomes 414 related to the machine-learning model to be trained. The stage inputs 412 are from any applicable source, including text, visual representations, data, values, comparisons, and stage outputs, e.g., one or more outputs from one or more steps from FIG. 3. The known outcomes 414 are included for the machine-learning models generated based on supervised or semi-supervised training or can be based on known labels, such as item category labels. An unsupervised machine-learning model is not trained using the known outcomes 414. The known outcomes 414 include known or desired outputs for future inputs similar to or in the same category as the stage inputs 412 that do not have corresponding known outputs.

The training data 410 and a training algorithm 420, e.g., one or more of the modules implemented using the machine-learning model and/or used to train the machine-learning model, are provided to a training component 430 that applies the training data 410 to the training algorithm 420 to generate the machine-learning model. According to an implementation, the training component 430 is provided with comparison results 416 that compare a previous output of the corresponding machine-learning model to apply the previous result to re-train the machine-learning model. The comparison results 416 are used by the training component 430 to update the corresponding machine-learning model. The training algorithm 420 utilizes machine-learning networks and/or models including, but not limited to, deep learning networks such as Deep Neural Networks (DNN), Convolutional Neural Networks (CNN), Fully Convolutional Networks (FCN), and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data and/or input data. The resulting outputs are adjusted based on the adjusted weights and/or layers.

The initial training of the machine-learning model for item categorization can be completed by utilizing item page data that has been tagged for certain categories. In some embodiments, this tagged data serves as an input for supervised or semi-supervised learning approaches. The tagging process can be done manually or automatically, depending on the desired level of accuracy and available resources.

Manual tagging involves human annotators who examine item pages and assign appropriate category labels based on the content and context of the item. This method can yield high-quality labeled data, as humans can understand nuances and contextual information better than automated algorithms. However, manual tagging can be time-consuming and labor-intensive, especially when dealing with large datasets.

Automatic tagging, on the other hand, involves using algorithms, such as natural language processing techniques or pre-trained machine-learning models, to assign category labels to item pages. This approach is faster and more scalable than manual tagging but may not be as accurate, particularly when dealing with complex or ambiguous items. To improve the accuracy of automatic tagging, it can be combined with manual tagging in a semi-supervised learning approach, where a smaller set of manually tagged data is used to guide the automatic tagging process.

The data collection process can be done manually or using web-scraping techniques. Manual data collection involves browsing websites and gathering item page information, which can be time-consuming and may not cover all the available item pages on the internet. Web-scraping techniques, on the other hand, use automated tools and scripts to extract item page data from various sources, making the process faster and more comprehensive.

Once the item page data has been collected and tagged with appropriate category labels, it can be used as input for the machine-learning model's training process. The model will learn to recognize patterns and features in the data that correspond to specific item categories. With sufficient training and accurate labeled data, the machine-learning model can become adept at categorizing new, unseen item pages, enabling an efficient and effective item categorization system.

In some embodiments, one or more additional sources of data are utilized for training data. For example, customer receipts may be utilized as source data, either alone or in combination with item page data associated with one or more item. The customer receipts may be accessed by the system either through scanning of physical receipts, or from data associated with one or more user account, such as a transaction record within the user account (which may be considered an electronic receipt, in some embodiments). The transaction record may include data associated with one or more transaction, each transaction associated with one or more items, and each item associated with one or more merchant. The association with the merchant may include, in some embodiments, association with a webpage associated with the item, such as earlier described. Data about the transaction may include item names, merchant and/or item categories, timestamps, prices, locations, and other data typically associated with transactions.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in FIGS. 2A-4, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

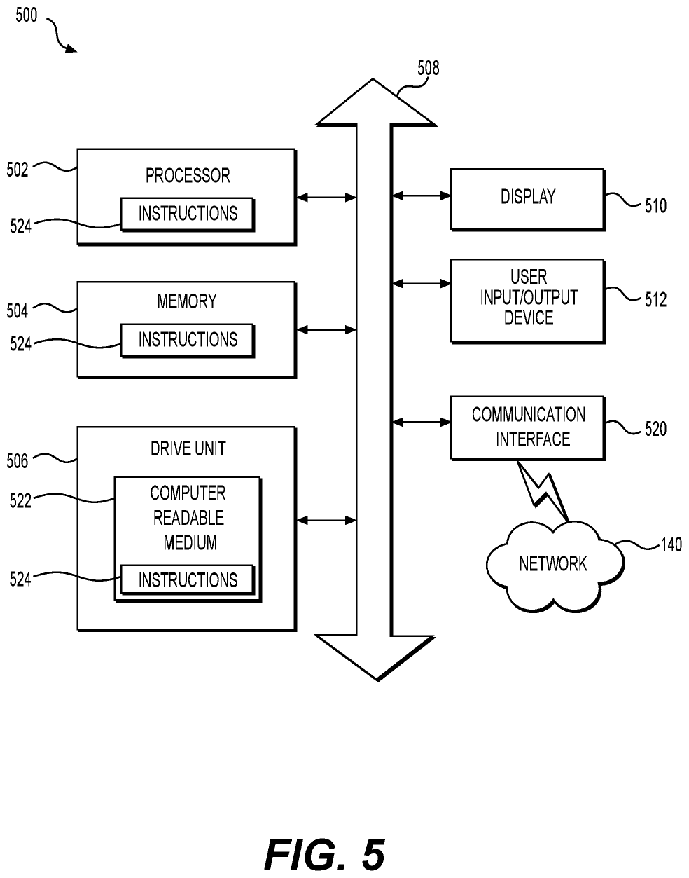

FIG. 5 is a simplified functional block diagram of a computer 500 that may be configured as a device for executing the methods of FIGS. 2A-4, according to exemplary embodiments of the present disclosure. For example, the computer 500 may be configured as the categorization platform(s) 200 and/or another system according to exemplary embodiments of this disclosure. In various embodiments, any of the systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “items” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for categorization, comprising:
initiating a local instance of a widget on a device of a user, the widget including a first model;
retrieving, by the widget, a first data set from the device of the user, the first data set associated with one or more datum of an active user session;
scoring, by the model, a first item associated with the active user session based at least in part on the first data set;
labeling a category for the first item based on a result of the scoring; and
sending, by the widget, a result of said labeling to a remote server.

2. The method of claim 1, wherein the one or more datum is continuously received throughout the active user session and includes one or more of HyperText Markup Language (HTML) code, metadata, or an item tag.

3. The method of claim 1, wherein the scoring is further based on one or more user interactions via the active user session that are indicative of one or more user behavior.

4. The method of claim 1, wherein the scoring includes generating a ranking of potential item categories for the first item.

5. The method of claim 4, further comprising verifying that said scoring results in at least one potential item category which satisfies a pre-defined threshold.

6. The method of claim 4 wherein said labeling comprises:
selecting for the first item a first item category, the first item category being a highest scoring potential item category of a plurality of potential item categories.

7. The method of claim 1, wherein said labeling comprises:
verifying that no potential item category satisfies a pre-defined threshold; and
selecting for the first item a default item category, the default item category being associated with none of the potential item categories.

8. The method of claim 1, wherein said model is a machine learning model, and said scoring is performed by said machine learning model.

9. The method of claim 1 wherein the method further includes adjusting a user experience based on a result of the labeling.

10. The method of claim 9, wherein adjusting the user experience includes binding a first instrument of the user to an instrument item category such that the first instrument is unable to complete a workflow for an item outside of said instrument item category.

11. A system for categorization, comprising:
a memory storing instructions and a trained machine learning model trained, based on item information data and ground truth, to learn associations between an item offering and one or more categories and to output an item label category in response to an input data set; and
a processor operatively connected to the memory and configured to execute the instructions to perform operations including:
initiating a local instance of a widget on a device of a user, the widget including a first instance of the machine learning model;
retrieving, by the widget, a first data set from the device of the user, the first data set associated with one or more datum of an active user session;
scoring, by the first instance of the machine learning model, a first item based at least in part on the first data set;
labeling a category for the first item based on a result of the scoring; and
sending, by the widget, a result of said labeling to a remote server.

12. The system of claim 11, wherein the one or more datum is retrieved during the active user session and includes one or more of HyperText Markup Language (HTML) code, metadata, or an item tag.

13. The system of claim 11, wherein the scoring is further based on one or more user behaviors.

14. The system of claim 11, wherein the scoring includes generating a ranking of potential item categories for the first item.

15. The system of claim 14, wherein the operations further include verifying that said scoring results in at least one potential item category which satisfies a pre-defined threshold.

16. The system of claim 15, wherein said labeling comprises:
selecting for the first item a first item category, the first item category being a highest scoring potential item category of a plurality of potential item categories.

17. The system of claim 11, wherein said first instance of the machine learning model is periodically updated based on additional training of the machine learning model.

18. The system of claim 11 wherein the operations further include adjusting a user experience based on a result of the labeling.

19. The system of claim 18, wherein adjusting the user experience includes binding a first instrument of the user to an instrument item category such that the first instrument is unable to complete a workflow for an item outside of said instrument item category.

20. A computer-implemented method for dynamic item recommendations, comprising:
receiving a first request from a user, the first request including one or more user preferences, user attributes, or contextual data;
retrieving one or more data sets associated with user behavior data from one or more data sources, the user behavior data including one or more of browsing history, purchase history, item ratings, or reviews;
scoring a set of items based on the retrieved data sets using a machine learning model, the machine learning model being trained on an item feature space that represents item attributes and characteristics;
selecting, based on a result of the scoring, one or more items as recommended items for the user, the one or more items being selected based on their scores and relevance to one or more of user behavior data, user preferences, attributes, or contextual data; and
presenting the recommended items to the user on a user interface.
